(19) United States
(12) Patent Application Publication
(10) Pub. No.: US 2024/0318020 A1
(43) Pub. Date: Sep. 26, 2024

(54) FABRIC INKJET INK, INKJET RECORDING METHOD, AND RECORDED MATTER

(71) Applicants: Tomohiro Nakagawa, Kanagawa (JP); Hiroki Kobayashi, Kanagawa (JP); Daiki Hyakutake, Kanagawa (JP)

(72) Inventors: Tomohiro Nakagawa, Kanagawa (JP); Hiroki Kobayashi, Kanagawa (JP); Daiki Hyakutake, Kanagawa (JP)

(73) Assignee: Ricoh Company, Ltd., Tokyo (JP)

(21) Appl. No.: 18/611,782

(22) Filed: Mar. 21, 2024

(30) Foreign Application Priority Data
Mar. 24, 2023 (JP) 2023-048607
Jan. 23, 2024 (JP) 2024-008158

(51) Int. Cl. C09D 11/322; D06P 5/30

(52) U.S. Cl. CPC C09D 11/322; D06P 5/30

(57) ABSTRACT

Provided is a fabric inkjet ink including water, a water-soluble organic solvent, a resin, and a pigment. The water-soluble organic solvent comprises at least one member selected from the group consisting of glycol ethers and glycols having six or more carbon atoms. The resin comprises an acrylic silicone resin and a urethane resin at a mass ratio of from 1:1 to 1:3, and the urethane resin comprises at least one member selected from the group consisting of polyester-based urethane resins and polyether-based urethane resins.

### CROSS-REFERENCE TO RELATED APPLICATIONS

This patent application is based on and claims priority pursuant to 35 U.S.C. § 119(a) to Japanese Patent Application Nos. 2023-048607 and 2024-008158, filed on Mar. 24, 2023 and Jan. 23, 2024, in the Japan Patent Office, the entire disclosure of each of which is hereby incorporated by reference herein.

### BACKGROUND

### Technical Field

The present disclosure relates to a fabric inkjet ink, an inkjet recording method, and recorded matter.

### Related Art

Inkjet printers have a number of advantages such as less noise, low running cost, and ease of color printing, and are now widely used at home as output devices of digital signals.

In recent years, there has been a need for an inkjet recording method to confer an image quality as high as conventional analog printing, not only on home use but also on non-absorbable media including slowly-permeable media, such as coated paper, and plastic films, and fabrics including woven fabrics and knit fabrics.

As well, the field of print dyeing has a year-by-year increasing market of so-called DTG (direct to garment) printing, which performs direct printing on clothing such as T-shirts with aqueous ink. In addition to conventional application to cotton or cotton-polyester blended media, DTG printing has rapidly growing demand for application to sportswear and thus is required to have adjustability to polyester media. Such a trend is recognized not only in the field of DTG printing but also in the whole field of textile printing, and demand is increasing more and more for an inkjet recording system that enables formation of images with excellent color developing and various robustness on fabrics of various materials including cotton and polyester by an inkjet printer including a winding-unwinding mechanism.

As inks directed to these fields, dye inks employing a reactive dye, an acidic dye, or the like have been widely used. However, dye inks have a disadvantage of placing a large burden on environment due to a post-treatment process including a washing process with a massive amount of water. Under this circumstance, in view of simplicity of operation including only a heating process, and versatility for use without any limitation to base materials, pigment inks have drawn an increasing expectation.

Nevertheless, pigment inks have a composition to adhere as solid contents onto fiber, and thus have a drawback that rubbing of a final printed matter tends to produce conspicuous flaking in an image and that addition of a large amount of a fixing component to remedy this problem provides a printed matter with a coarse feel and significantly reduces a hand feel (hereinafter referred to as texture), which is placed with importance in the field of apparel.

### SUMMARY

Embodiments of the present invention provide a fabric inkjet ink including water, a water-soluble organic solvent, a resin, and a pigment. The water-soluble organic solvent comprises at least one member selected from the group consisting of glycol ethers and glycols having six or more carbon atoms. The resin comprises an acrylic silicone resin and a urethane resin at a mass ratio of from 1:1 to 1:3, and the urethane resin comprises at least one member selected from the group consisting of polyester-based urethane resins and polyether-based urethane resins.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an inkjet recording apparatus that uses a fabric inkjet ink according to an embodiment of the present invention; and

FIG. 2 is a perspective view of a main tank in the inkjet recording apparatus of FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

Embodiments of the present invention provides a fabric inkjet ink having high levels of texture and friction fastness.

### (Fabric Inkjet Ink)

First, description will be made for a fabric inkjet ink according to the present embodiment.

The fabric inkjet ink according to the present embodiment contains at least water, a water-soluble organic solvent, a resin, and a pigment. The resin contains an acrylic silicone resin and a urethane resin at a mass ratio of from 1:1 to 1:3. The urethane resin contains at least one member selected from the group consisting of polyester-based urethane resins and polyether-based urethane resins. The water-soluble organic solvent contains at least one member selected from the group consisting of glycol ethers and glycols having six or more carbon atoms.

### <Fabric>

Embodiments of the present invention provide an inkjet ink for fabric (hereinafter “fabric inkjet ink”), which is an inkjet ink suitably used for fabric.

The term “fabric” as used herein refers to a fiber formed into a woven fabric, a knitted fabric, a woven cloth, an unwoven cloth or the like. The fiber has any thickness and mesh size without limitation.

The fiber is not particularly limited and can be suitably selected according to a purpose. Examples thereof include, but are not limited to, natural fibers, chemical fibers, biodegradable fibers, and blended fibers thereof.

Examples of the natural fibers include, but are not limited to, fibers made of cotton, hemp, wool, silk or the like, and blended fiber thereof. Preferred is cotton, and particularly preferred is a cotton fiber.

Examples of the chemical fibers include, but are not limited to, recycled fibers, synthesized fibers, semi-synthesized fibers, and blended fibers thereof.

Examples of the recycled fibers include, but are not limited to, fibers made of viscose, lyocell, polynodic, rayon, cupra or the like, and blended fibers thereof.

Examples of the synthesized fiber include, but are not limited to, fibers made of polypropylene, polyester, acetate, triacetate, polyurethane, polyamide, polyimide, acryl, polyvinyl alcohol, polyvinyl chloride, nylon, NOMEX (manufactured by DuPont de Nemours, Inc.), KEVLAR (manufactured by DuPont de Nemours, Inc.) or the like, and blended fiber thereof.

Examples of the semi-synthesized fibers include, but are not limited to, fibers made of acetate, diacetate, triacetate or the like, and blended fibers thereof.

Examples of the biodegradable fibers include, but are not limited to, fibers made of polylactate or the like.

### <Water>

The fabric inkjet ink according to the present embodiment contains water. Available examples of the water include, but are not limited to, distilled water, ion-exchanged water, ultrafiltered water, reverse osmosis water, pure water, highly-pure water, and ultrapure water. Each of these can be used alone or in combination with others.

The content of water in the fabric inkjet ink according to the present embodiment is not particularly limited and can be suitably selected according to a purpose.

### <Water-Soluble Organic Solvent>

The fabric inkjet ink according to the present embodiment contains a water-soluble organic solvent, and the water-soluble organic solvent contains at least one member selected from the group consisting of glycol ethers and glycols having six or more carbon atoms.

The total content of the water-soluble organic solvent in the ink is not particularly limited and can be suitably selected according to a purpose, but is, in view of dryability and preservation stability of ink, preferably 1% by mass or more to 40% by mass or less, and more preferably 2% by mass or more to 30% by mass or less.

The water-soluble organic solvent may contain only one member or two or more members selected from the above-described group.

Inclusion of at least one member selected from the group consisting of glycol ethers and glycols having six or more carbon atoms in the water-soluble organic solvent provides improved wettability of ink to a base material and thus increased adhesion between the ink and the base material, and furthermore, resin particles (to be described later) have a plasticizing effect and thereby promote fusion of the resin, resulting in a film with more strength and firmness.

The additive amount of the glycol ether(s) and/or the glycol(s) having six or more carbon atoms is preferably 0.5% by mass or more to 15% by mass or less, and more preferably 1% by mass or more to 10% by mass or less relative to the total amount of ink, in view of ensuring storage stability of ink.

### <<Glycol Ethers and Glycols Having Six or More Carbon Atoms>>

The glycol ethers and the glycols having six or more carbon atoms are not particularly limited and can be suitably selected according to a purpose.

Examples of the glycol ethers include, but are not limited to, ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether.

Examples of the glycols having six or more carbon atoms include, but are not limited to, triethylene glycol, 1,2-hexanediol, 1,6-hexanediol, 1,3-hexanediol, 2,5-hexanediol, 1,5-hexanediol, 1,2,6-hexanetriol, 2-ethyl-1,3-hexanediol, ethyl-1,2,4-butanetriol, 1,2,3-butanetriol, 2,2,4-trimethyl-1,3-pentanediol, 2-ethyl-1,3-hexanediol, and 2,2,4-trimethyl-1,3-pentanediol.

### <<Other Water-Soluble Organic Solvents>>

The fabric inkjet ink according to the present embodiment may contain another water-soluble organic solvent, e.g., in view of ensuring discharge stability at a nozzle section.

The other water-soluble organic solvent available for the present embodiment is not particularly limited. Examples thereof include, but are not limited to, polyhydric alcohols, ethers such as polyhydric alcohol aryl ethers, nitrogen-containing heterocyclic compounds, amides, amines, sulfur-containing compounds, and other organic solvents.

Examples of the polyhydric alcohols include, but are not limited to, glycols with five carbon atoms or less. Specific examples of the polyhydric alcohols include, but are not limited to, ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, 1,2-pentanediol, 1,3-pentanediol, 1,4-pentanediol, 2,4-pentanediol, 1,5-pentanediol, and glycerin.

Examples of the polyhydric alcohol aryl ethers include, but are not limited to, ethylene glycol monophenyl ether and ethylene glycol monobenzyl ether.

Examples of the nitrogen-containing heterocyclic compounds include, but are not limited to, 2-pyrrolidone, N-methyl-2-pyrrolidone, N-hydroxyethyl-2-pyrrolidone, 1,3-dimethyl-2-imidazolidinone, ε-caprolactam, and γ-butyrolactone.

Examples of the amides include, but are not limited to, formamide, N-methylformamide, N,N-dimethylformamide, 3-methoxy-N,N-dimethylpropionamide, and 3-butoxy-N,N-dimethylpropionamide.

Examples of the amines include, but are not limited to, monoethanolamine, diethanolamine, and triethylamine.

Examples of the sulfur-containing compounds include, but are not limited to, dimethylsulfoxide, sulfolane, and thiodiethanol.

Examples of the other organic solvents include, but are not limited to, propylene carbonate and ethylene carbonate.

### <Resin>

The fabric inkjet ink used in the present embodiment contains a resin, and the resin contains an acrylic silicone resin and a urethane resin.

The resin in the fabric inkjet ink according to present embodiment may be added in any form to the ink, but is preferably contained in an emulsion form.

An emulsion form herein refers to a state where the resin is dispersed as microparticles (hereinafter maybe referred to as “particles” or “resin particles”) in an ink composition.

When the resin is present in an emulsion form, water, which is typically a main solvent of an aqueous ink, or a water-soluble organic solvent in the ink volatilizes and permeates, thereby causing binding among resin particles, and allowing promotion of fixation of a pigment to a recording medium.

When the resin is added in an emulsion form, the volume average particle diameter of the resin particles is not particularly limited and can be suitably selected according to a purpose, but preferably 10 nm or more to 1,000 nm or less, and more preferably 10 nm or more to 300 nm or less.

Within the aforementioned range, the ink does not have too high viscosity, as well as provides particles with good film formability, resulting in high friction fastness.

The volume average particle diameter of the resin particles can be measured with, e.g., a particle size analyzer (NANOTRAC WAVE-UT151 manufactured by MicrotracBEL Corp.).

In measurement of the volume average particle diameter of the resin particles with a particle size analyzer (NANOTRAC WAVE-UT151 manufactured by MicrotracBEL Corp.), for example, a resin emulsion solution to be a measurement sample is diluted with highly-pure water so as to provide scattered light strength fallen within any measurement range, and then put into a cell and subjected to measurement, thereby measuring the volume average particle diameter of the resin particles.

The content of the resin is not particularly limited and can be suitably selected according to a purpose, but is, in view of fixability and preservation stability of the ink, preferably 1% by mass or more to 30% by mass or less, and more preferably 5% by mass or more to 20% by mass or less relative to the total amount of the ink.

The acrylic silicone resin and the urethane resin have a mass ratio ranging from 1:1 to 1:3 in the ink. When the urethane resin is excessively present at a ratio beyond 1:3, a printed matter can be provided with poor texture. When the acrylic silicone resin is excessively present at a ratio beyond 1:1, the urethane resin can poorly provide toughness, causing reduced friction fastness.

### <<Acrylic Silicone Resin>>

The fabric inkjet ink according to the present embodiment contains an acrylic silicone resin as a resin. Without an acrylic silicone resin, the ink does not have lubricity, which is characteristic of a silicone resin, and thus fails to lead to reduction in a friction coefficient, resulting in less friction fastness as well as poor texture.

The acrylic silicone resin as described above should be a copolymer having repeating units of (meth)acrylic ester (acrylic-based component units) and repeating units of siloxane (siloxane-based component units) in a structure.

Such an acrylic silicone resin can contain, e.g., both of an acrylic resin including acrylic component units as a main component, and a polysiloxane-based resin having, as a main backbone, a polysiloxane structure including siloxane-based structure units.

In addition, the term “(meth)acryl” means both of “acryl” and “methacryl”. Note that the term “acryl modified silicone resin” as used herein may be referred to as “acrylic silicone resin”.

The acrylic silicone resin is preferably present as resin particles in the ink. The volume average particle diameter of resin particles of the acrylic silicone resin is not particularly limited and can be suitably selected according to a purpose, but is preferably 10 nm or more to 1,000 nm or less, and more preferably 10 nm or more to 300 nm or less.

When the acrylic silicone resin particles in the ink have a volume average particle diameter falling within the aforementioned range, the ink does not have too high viscosity, as well as provides particles with good film formability, resulting in high friction fastness.

More specifically, the acrylic silicone resin can contain an acrylic resin covalently bound to a polysiloxane based resin, and examples thereof can include, but are not limited to, an acrylic silicone-based block copolymer containing an acrylic resin bound to a polysiloxane-based resin mutually at the terminal ends, an acrylic silicone-based graft copolymer having a polysiloxane-based resin as a main backbone with a side chain bound to an acrylic resin, an acrylic silicone-based graft copolymer having an acrylic resin as a main backbone with a side chain bound to a polysiloxane-based resin, and a conjugate of these copolymers.

Since the acrylic silicone resin takes a form of the copolymer as described above, an area in a recorded matter to which the inkjet ink according to the present embodiment is applied has a less friction coefficient due to good lubricity from a silicone resin, and allows formation of a uniformly coated film mixed with the urethane resin described later due to good miscibility from an acryl resin.

On type of the acrylic silicone resin may be included alone in the ink, or two or more types of the acrylic silicone resins may be included in the ink in combination.

The acrylic component unit is not particularly limited. However, in view of increasing strength of a film and miscibility with a urethane resin after drying of the ink according to the present embodiment, the acrylic silicone resin preferably contains, as a main component, component units derived from (meth)acrylate ester monomers having no acid group and no hydroxyl group.

Examples of the (meth)acrylate ester monomer having no acid group and no hydroxyl group include, but are not limited to, methyl (meth)acrylate, ethyl (meth)acrylate, propyl (meth)acrylate, butyl (meth)acrylate, pentyl (meth)acrylate, hexyl (meth)acrylate, 2-ethylhexyl (meth)acrylate, octyl (meth)acrylate, nonyl (meth)acrylate, dodecyl (meth)acrylate, stearyl (meth)acrylate, cyclopentyl (meth)acrylate, cyclohexyl (meth)acrylate, and 2-methylcyclohexyl (meth)acrylate.

A component unit for forming the polysiloxane structure (siloxane component unit) is not particularly limited, but in view of providing a final product of an ink coated film with good lubricity and texture, preferably contains the component unit represented by the following general formula (1) as a main component:

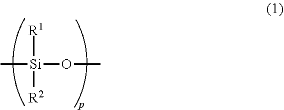

In the general formula (1), R¹ and R² are each independently a hydrogen atom, an alkyl group having 1 to 4 carbon atoms, or a phenyl group, and a plurality of R¹s and R²s may be the same as or different from each other. In addition, p is an integer of 2 or more.

As the siloxane component unit, a siloxane component unit other than the component unit represented by the general formula (1) may be contained. As such another siloxane component unit, a radical polymerizable siloxane component unit having a radical polymerizable group may be contained, for example.

Inclusion of a radical polymerizable siloxane component unit allows polymerization with a (meth)acrylate ester monomer forming an acrylic resin, via a radical polymerizable group.

Thus, it is possible to easily produce, e.g., an acrylic silicone resin containing an acrylic resin bound to a polysiloxane-based resin.

Such a radical polymerizable silane compound potentially forming a radical polymerizable siloxane component unit should potentially bind to the component unit represented by the general formula (1) via a polysiloxane bond.

As a method of synthesizing the acrylic silicone resin, known methods can be used.

Available examples thereof include, but are not limited to, a methods where a polysiloxane macromonomer having a polymerizable group, such as a (meth)acryloyl group, a vinyl group, a styryl group, an epoxy group, an alkoxysilyl group, or a mercapto group, at a terminal end is subjected to emulsion polymerization with a (meth)acrylate ester, as described in Japanese Unexamined Patent Application Publication No. 09-87586.

Another available of the synthesis method is that a polysiloxane-based resin having a polymerizable siloxane component unit is synthesized as the polysiloxane-based resin and then subjected to emulsion polymerization with a (meth)acrylate ester monomer that can form an acrylic resin.

Examples of commercially-available products of the acrylic silicone resin emulsion include, but are not limited to, CHALINE FE-502 (manufactured by Nissin Chemical Co., Ltd.), CHALINE R-170BX (manufactured by Nissin Chemical Co., Ltd.), ACRIT KS-3705 (manufactured by Taisei Fine Chemical Co., Ltd.), MOWINYL LDM7523 (manufactured by The Nippon Synthetic Chemical Industry Co., Ltd. (present Mitsubishi Chemical Corporation)), AE980 (manufactured by JSR Corporation), AE981A (manufactured by JSR Corporation), AE982 (manufactured by JSR Corporation), and POLYSOL AP-3900 (manufactured by Showa Denko K.K. (present Resonac Holdings Corporation)).

### <<Urethane Resin>>

The fabric inkjet ink according to the present embodiment also contains a urethane resin as a resin as described above, and the urethane resin contains at least one member selected from the group consisting of polyester-based urethane resins and polyether-based urethane resins.

Without a urethane resin in the ink, the ink fails to have sufficient toughness, and thus has poor friction fastness.

In view of wet friction fastness of a fabric, the ink according to the present embodiment preferably contains a polyester-based urethane resin, a polyether-based urethane resin, or the like.

A urethane resin in the present embodiment can be exemplified by a polyurethane resin derived by reacting polyol with polyisocyanate. A polyester-based urethane resin (polyester urethane) refers to a resin derived by using polyester polyol as polyol, and a polyether-based urethane resin (polyether urethane) refers to a resin derived by using polyether polyol as polyol.

The urethane resin is preferably present as resin particles in the ink, and the volume average particle diameter of resin particles of the urethane resin is not particularly limited and can be suitably selected according to a purpose, but is preferably 10 nm or more to 1,000 nm or less, and more preferably 10 nm or more to 300 nm or less.

Within the aforementioned range, the ink does not have too high viscosity, as well as provides particles with good film formability, resulting in high friction fastness.

### —Polyether Polyol—

Examples of the polyether polyol include, but are not limited to, those derived by addition polymerization of alkylene oxide to at least one type of compound having two or more active hydrogen atoms as a starting raw material.

Examples of the compound having two or more active hydrogen atoms include, but are not limited to, ethylene glycol, diethylene glycol, triethylene glycol, propylene glycol, trimethylene glycol, 1,3-butanediol, 1,4-butanediol, 1,6-hexanediol, glycerin, trimethylolethane, and trimethylolpropane. Each of these can be used alone or in combination with others.

Examples of the alkylene oxide include, but are not limited to, ethylene oxide, propylene oxide, butylene oxide, styrene oxide, epichlorohydrin, and tetrahydrofuran. Each of these can be used alone or in combination with others.

### —Polyester Polyol—

Examples of the polyester polyol include, but are not limited to: those obtained by an esterification reaction of a low-molecular-weight polyol with a polycarboxylic acid; polyesters obtained by a ring-opening polymerization reaction of a cyclic ester compound such as ε-caprolactone; and copolymer polyesters thereof. Each of these can be used alone or in combination with others.

Examples of the low-molecular-weight polyol include, but are not limited to, ethylene glycol and propylene glycol. Each of these can be used alone or in combination with others.

Examples of the polycarboxylic acid include, but are not limited to, succinic acid, adipic acid, sebacic acid, dodecanedicarboxylic acid, terephthalic acid, isophthalic acid, phthalic acid, and anhydrides and ester-forming derivatives thereof. Each of these can be used alone or in combination with others.

### —Polyisocyanate—

Examples of the polyisocyanate include, but are not limited to: aromatic diisocyanates such as phenylene diisocyanate, tolylene diisocyanate, diphenylmethane diisocyanate, and naphthalene diisocyanate; and aliphatic or alicyclic diisocyanates such as hexamethylene diisocyanate, lysine diisocyanate, cyclohexane diisocyanate, isophorone diisocyanate, dicyclohexylmethane diisocyanate, xylylene diisocyanate, tetramethylxylylene diisocyanate, and 2,2,4-trimethylhexamethylene diisocyanate. Each of these can be used alone or in combination with others. In particular, the ink according to the present embodiment is also used for outdoor applications such as posters and signboards and thus should form a coated film with extremely high long-term resistance to weather. In view of the long-term resistance to weather, alicyclic diisocyanate is preferred.

Furthermore, use of at least one type of alicyclic diisocyanate tends to provide desired coated film strength and abrasion resistance.

Examples of the alicyclic diisocyanates include, but are not limited to, isophorone diisocyanate and dicyclohexylmethane diisocyanate.

The content of the alicyclic diisocyanates is preferably 60% by mass or more relative to the total amount of isocyanate compounds.

The polyurethane resin (including resin particles) can be produced by a production method conventionally and typically used such as the following method.

First, in the presence of no solvent or an organic solvent, the polyol and the polyisocyanate are reacted in an equivalent ratio to contain an excess amount of isocyanate groups, thereby producing an isocyanate-terminated urethane prepolymer.

Next, anionic groups in the isocyanate-terminated urethane prepolymer are neutralized with a neutralizer, if necessary. The isocyanate-terminated urethane prepolymer is then reacted with a chain extender, followed by removal of the organic solvent from the reaction system, if necessary, thereby finally producing the resin.

Examples of an organic solvent potentially used in producing the polyurethane resin (including resin particles) include, but are not limited to: ketones such as acetone and methyl ethyl ketone; ethers such as tetrahydrofuran and dioxane; acetate esters such as ethyl acetate and butyl acetate; nitriles such as acetonitrile; and amides such as dimethylformamide, N-methylpyrrolidone, and N-ethylpyrrolidone. Each of these can be used alone or in combination with others.

Examples of the chain extender include, but are not limited to, polyamines and other compounds having an active hydrogen group.

Examples of the polyamines include, but are not limited to: diamines such as ethylenediamine, 1,2-propanediamine, 1,6-hexamethylenediamine, piperazine, 2,5-dimethylpiperazine, isophoronediamine, 4,4′-dicyclohexylmethanediamine, and 1,4-cyclohexanediamine; polyamines such as diethylenetriamine, dipropylenetriamine, and triethylenetetramine; hydrazines such as hydrazine, N,N′-dimethylhydrazine, and 1,6-hexamethylenebishydrazine; and dihydrazides such as succinic acid dihydrazide, adipic acid dihydrazide, glutaric acid dihydrazide, sebacic acid dihydrazide, and isophthalic acid dihydrazide. Each of these can be used alone or in combination with others.

Examples of the other compounds having an active hydrogen group include, but are not limited to: glycols such as ethylene glycol, diethylene glycol, triethylene glycol, propylene glycol, 1,3-propanediol, 1,3-butanediol, 1,4-butanediol, hexamethylene glycol, sucrose, methylene glycol, glycerin, and sorbitol; phenols such as bisphenol A, 4,4′-dihydroxydiphenyl, 4,4′-dihydroxydiphenyl ether, 4,4′-dihydroxydiphenyl sulfone, hydrogenated bisphenol A, and hydroquinone; and water. Each of these compounds can be used alone or in combination with others, as far as the ink is not provided with reduced preservation stability.

As the polyurethane resin (including resin particles), commercially-available products may be used, and examples thereof include, but are not limited to, UCOAT UWS-145 (polyester-based polyurethane resin particle) and PERMARIN UA-200 (polyether-based polyurethane resin particle) (the listed above are manufactured by Sanyo Chemical Industries, Ltd.); and SUPERFLEX 130 (polyether-based polyurethane; volume average particle diameter: 30 nm) and SUPERFLEX 210 (polyester-based polyurethane; volume average particle diameter: 40 nm) (the listed above are manufactured by DKS Co., Ltd.). Each of these can be used alone or in combination with others. Detection of the polyisocyanate by gas chromatography mass spectrometry (GC-MS) provides a determination of presence of the urethane resin.

### <Pigment>

The fabric inkjet ink according to the present embodiment contains a pigment, and an inorganic pigment or an organic pigment can be used as the pigment. Each of these materials can be used alone or in combination with others. Mixed crystals can also be used as the pigment.

The pigment in the fabric inkjet ink according to the present embodiment may be added in any form into the ink, but is preferably added in a form of a pigment dispersion.

The content of the pigment in the fabric inkjet ink according to the present embodiment is not particularly limited and can be suitably selected according to a purpose, but is, in view of providing stable discharge, preferably 1% by mass or more to 10% by mass or less, and more preferably 2% by mass or more to 10% by mass or less.

Available examples of the pigment in the fabric inkjet ink include, but are not limited to, black pigments, yellow pigments, magenta pigments, cyan pigments, white pigments, green pigments, orange pigments, glossy color pigments such as gold pigments and silver pigments, and metallic pigments.

Available examples of the inorganic pigment include, but are not limited to, titanium oxide, iron oxide, calcium carbonate, barium sulfate, aluminum hydroxide, barium yellow, cadmium red, and chrome yellow, as well as carbon black produced by a known method such as a contact method, a furnace method, or a thermal method.

Available examples of the organic pigment include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye chelates and acid dye chelates), nitro pigments, nitroso pigments, and aniline black.

Among these pigments, those having good miscibility with a solvent such as the water-soluble organic solvent or water are preferably used as a pigment in the fabric inkjet ink. In addition, hollow resin particles and hollow inorganic particles can also be used.

For specific examples of the pigment, examples of pigments for black include, but are not limited to: carbon blacks (i.e., C.I. Pigment Black 7) such as furnace black, lamp black, acetylene black, and channel black; metals such as copper and iron (i.e., C.I. Pigment Black 11); and organic pigments such as aniline black (i.e., C.I. Pigment Black 1). Examples of pigments for white include, but are not limited to, titanium oxide, titanium dioxide, and hollow resin particles.

Specific examples of pigments for color printing include, but are not limited to: C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (red iron oxide), 104, 105, 106, 108 (cadmium red), 112, 114, 122 (quinacridone magenta), 123, 146, 149, 166, 168, 170, 172, 177, 178, 179, 184, 185, 190, 193, 202, 207, 208, 209, 213, 219, 224, 254, and 264; C.I. Pigment Violet 1 (rhodamine lake), 3, 5:1, 16, 19, 23, and 38; C.I. Pigment Blue 1, 2, 15 (phthalocyanine blue), 15:1, 15:2, 15:3, 15:4 (phthalocyanine blue), 16, 17:1, 56, 60, and 63; and C.I. Pigment Green 1, 4, 7, 8, 10, 17, 18, and 36.

### <Pigment Dispersion>

The pigment dispersion can be produced by mixing and dispersing water, an organic solvent, and a pigment, and also, as appropriate, a pigment dispersant; further admixing another component, as appropriate; and then adjusting particle diameters.

A method of dispersing the pigment to prepare a pigment dispersion is not particularly limited, and can be appropriately selected from known methods. Examples thereof include, but are not limited to, a method of production by mixing the pigment with a material, such as water or an organic solvent, and a method of production by mixing the pigment and other substances, such as water and a pigment dispersant, to prepare a pigment dispersion that is then mixing with a material, such as water or an organic solvent.

The dispersion preferably employs a dispersing machine.

Preferably, the pigment dispersion is further subjected to, as appropriate, filtration using a filter or a centrifugal separator to remove coarse particles, followed by degassing.

The particle diameter of the pigment in the pigment dispersion is not particularly limited and can be suitably selected according to a purpose. Nevertheless, in view of providing good dispersion stability of the pigment and also improving discharge stability and image quality such as image density, the volume average particle diameter D50 of the pigment in the pigment dispersion is preferably 20 nm or more to 500 nm or less, and more preferably 20 nm or more to 150 nm or less.

The volume average particle diameter D50 of the pigment in the pigment dispersion can be measured using a particle size analyzer (NANOTRAC WAVE-UT151 manufactured by MicrotracBEL Corp.) in the same manner as described above.

The content of the pigment in the pigment dispersion is not particularly limited and can be suitably selected according to a purpose, but is, in view of providing good discharge stability and improving image density, preferably 0.1% by mass or more to 60% by mass or less, and more preferably 0.1% by mass or more to 50% by mass or less.

A method of dispersing the pigment to provide the pigment dispersion is not particularly limited and can be suitably selected according to a purpose. Examples thereof include, but are not limited to, a method of introducing a hydrophilic functional group into the pigment to prepare a self-dispersible pigment, a method of covering a surface of the pigment with a resin to prepare a resin-covered pigment that is then dispersed, and a method of providing a pigment dispersion by a method of dispersing the pigment with use of a dispersant such as a surfactant.

Production in the present embodiment preferably employs a pigment dispersion derived from a resin-covered pigment, in view of increasing miscibility between a resin separately added and the pigment.

Examples of the method of introducing a hydrophilic functional group into the pigment to prepare a self-dispersible pigment that is then dispersed include, but are not limited to, a method of adding a functional group such as a sulfone group or a carboxyl group to the pigment (e.g., carbon), thereby making the pigment dispersible in water.

Examples of a method of covering a surface of the pigment with a resin to prepare a resin-covered pigment that is then dispersed include, but are not limited to, a method of encapsulating the pigment into a resin microcapsule and thereby allowing dispersion in water. Such a pigment can be translated as a pigment covered with a resin. In this case, the pigment dispersion, and a pigment blended in the ink may not be fully covered with a resin. As far as an effect of the present embodiment is not impaired, a pigment uncovered with a resin or a pigment partially covered with a resin may be dispersed in the pigment dispersion and the ink.

Examples of a method of dispersing the pigment with use of a dispersant include, but are not limited to, a method of dispersing with a use of a known low-molecular dispersant represented by a surfactant, and a method of dispersing with a known high-molecular dispersant.

The dispersant is not particularly limited and can be appropriately selected corresponding to a pigment. Available example thereof include, but are not limited to, anion-based surfactants, cation-based surfactants, amphoteric surfactants, and nonionic surfactants.

Each of these can be used alone or in combination with others.

As the dispersant, an appropriately synthesized substance or a commercially-available product may be used.

Examples of the commercially-available product of the dispersant include, but are not limited to, the product named NEWKALGEN D-1203 (nonionic surfactant, manufactured by Takemoto Oil & Fat Co., Ltd.). Naphthalene sulfonic acid Na-formaldehyde condensates can also be preferably used as a dispersant.

### <Additive>

To the inkjet ink, a surfactant, a defoamer, a preservative and fungicide, a corrosion inhibitor, a pH adjuster or the like may be added as an additive, as appropriate.

### —Surfactant—

Available examples of a surfactant as the additive include, but are not limited to, silicone-based surfactants, fluorine-based surfactants, amphoteric surfactants, and nonionic surfactants.

The silicone-based surfactants are not particularly limited and can be suitably selected according to a purpose. In particular, preferred are surfactants that cannot be degraded even at high pH. Examples of the silicone-based surfactants include, but are not limited to, side-chain-modified polydimethylsiloxane, both-end-modified polydimethylsiloxane, one-end-modified polydimethylsiloxane, and side-chain-and-both-end-modified polydimethylsiloxane. Surfactants having a polyoxyethylene group and/or a polyoxyethylene polyoxypropylene group as a modifying group(s) are particularly preferred because of exerting good characteristics as an aqueous surfactant. Polyether-modified silicone-based surfactants can also be used as the silicone-based surfactants, and examples thereof include, but are not limited to, a compound having a polyalkylene oxide structure introduced in a side chain bound to Si of dimethylsiloxane.

Particularly preferred examples of the fluorine-based surfactants include, but are not limited to, perfluoroalkyl sulfonic acid compounds, perfluoroalkyl carboxylic acid compounds, perfluoroalkyl phosphate ester compounds, perfluoroalkyl ethylene oxide adducts, and polyoxyalkylene ether polymer compounds having a perfluoroalkyl ether group on a side chain, because of less foamability. Examples of the perfluoroalkyl sulfonic acid compounds include, but are not limited to, perfluoroalkyl sulfonic acid and perfluoroalkyl sulfonate salts. Examples of the perfluoroalkyl carboxylic acid compounds include, but are not limited to, perfluoroalkyl carboxylic acid and perfluoroalkyl carboxylate salts. Examples of the polyoxyalkylene ether polymer compounds having a perfluoroalkyl ether group on a side chain include, but are not limited to, a sulfate ester salt of a polyoxyalkylene ether polymer having a perfluoroalkyl ether group on a side chain, and a salt of a polyoxyalkylene ether polymer having a perfluoroalkyl ether group on a side chain. Examples of the counterions of salts in these fluorine-based surfactants include, but are not limited to, Li, Na, K, NH₄, NH₃CH₂CH₂OH, NH₂(CH₂CH₂OH)₂, and NH(CH₂CH₂OH)₃.

Examples of the amphoteric surfactants include, but are not limited to, laurylaminopropionate salt, lauryl dimethyl betaine, stearyl dimethyl betaine, and lauryl dihydroxyethyl betaine.

Examples of the nonionic surfactants include, but are not limited to, polyoxyethylene alkyl phenyl ethers, polyoxyethylene alkyl esters, polyoxyethylene alkylamines, polyoxyethylene alkylamides, polyoxyethylene propylene block polymers, sorbitan fatty acid esters, polyoxyethylene sorbitan fatty acid esters, and ethylene oxide adducts of acetylene alcohol.

The content of a surfactant as the additive in the inkjet ink according to the present embodiment is not particularly limited and can be suitably selected according to a purpose, but is, in view of providing good wettability and discharge stability and improving image quality, preferably 0.001% by mass or more to 5% by mass or less, and more preferably 0.05% by mass or more to 5% by mass or less.

### —Defoamer—

A defoamer as the additive is not particularly limited, and examples of thereof include, but are not limited to, silicone-based defoamers, polyether-based defoamers, and fatty-acid-ester-based defoamers. Each of these can be used alone or in combination with others. In particular, silicone-based defoamers are preferred in view of excellent defoaming effect.

### —Preservative and Fungicide—

A preservative and fungicide as the additive is not particularly limited, and examples thereof include, but are not limited to, 1,2-benzisothiazoline-3-one.

### —Corrosion Inhibitor—

A corrosion inhibitor as the additive is not particularly limited, and examples thereof include, but are not limited to, acid sulfite and sodium thiosulfate.

### —pH Adjuster—

A pH adjuster as the additive is not particularly limited as long as the pH adjuster can adjust the pH to 7 or higher. Examples thereof include, but are not limited to, amines such as diethanolamine and triethanolamine.

The fabric inkjet ink according to the present embodiment is not particularly limited and can be suitably selected according to a purpose as described above, but a dried ink film that is a dried substance derived by drying the inkjet ink according to the present embodiment has preferably a glass transition point (hereinafter described as Tg) of −40° C. to 25° C.

A dried substance produced by drying the ink according to the present embodiment has preferably a Tg of −40° C. to 25° C. When the Tg falls within such a range, a soft film is produced with followability to a base material and thus less likely to peel off upon pulling of the base material, and further, the film is also provided with appropriate toughness and thus has good friction fastness.

Examples of a method of controlling the Tg of the dried substance derived by drying the ink include, but are not limited to, controlling a Tg of a resin, a blend ratio of resins in addition of a plurality of resins, a blend ratio of resin/pigment, and a solvent species.

A dried ink film to be subjected to a Tg measurement test can be produced by charging the ink into a TEFLON dish, followed by drying at 40° C. for 12 hours and at 150° C. for 12 hours, and then drying under reduced pressure at 150° C. for 3 hours.

The glass transition temperature can be measured by using, e.g., the DSC system Q-2000 (manufactured by TA Instruments Ltd.). In detail, first, about 5.0 mg of a dried ink film in a sample container made of aluminum is set in the device, and subjected to measurement in nitrogen stream under the following measurement conditions. A DSC curve in the second heating can be selected and subjected to calculation for glass transition temperature by a midpoint method.

### [Measurement Conditions]

Cooling to −70° C. and then keeping for 5 minutes
Heating to 120° C. at 10° C./min
Cooling to −70° C. and then keeping for 5 minutes
Heating to 120° C. at 10° C./min

Examples of a qualitative method or a quantification method for water, an organic solvent, a resin, a pigment, and other components in the ink according to the present embodiment include, but are not limited to, gas chromatography mass spectrometry (GC-MS).

Examples of a measurement device for the gas chromatography mass spectrometry (GC-MS) include, but are not limited to, GCMS-QP2020NX (manufactured by Shimadzu Corporation).

The content of water in the ink can be measured by general methods such as quantification of volatile constituents by gas chromatography mass spectrometry (GC-MS), or mass variation by simultaneous thermogravimetric and differential thermal measurement (TG-DTA).

### (Recorded Matter)

A recorded matter according to the present embodiment includes a base material serving as a recording medium and an image formed on the base material with use of the fabric inkjet ink according to the present embodiment or an ink set thereof.

The recorded matter can be produced by applying the inkjet ink according to the present embodiment to a base material to record an image by an inkjet recording apparatus and an inkjet recording method.

### —Base Material—

A base material that can be used for the recorded matter according to the present embodiment is not particularly limited and can be suitably selected according to a purpose as far as an effect of the present embodiment is not impaired. Fabric is particularly preferred, and specific examples thereof can include, but are not limited to, the aforementioned fabric.

A fabric preferable for the recorded matter according to the present embodiment is similar to a fabric preferable for application of the aforementioned ink according to the present embodiment.

### (Recording Apparatus and Recording Method)

The fabric inkjet ink according to the present embodiment and the ink set thereof can be preferably used for various recording apparatuses employing an inkjet recording system, such as printers, facsimile machines, photocopiers, multifunction machines having functions of a printer, a facsimile machine, and a copier, and stereo forming apparatuses.

In the present embodiment, the recording apparatus and the recording method refer to an apparatus (e.g., inkjet recording apparatus) that allows discharge of ink or various treatment liquids onto a base material as a recording medium, and a method of recording (e.g., inkjet recording method) with use of the apparatus, respectively. The recording medium refers to a material to which ink or various treatment liquids can be attached at least temporarily.

The recording apparatus can include, in addition to a head portion to discharge ink, units relating to feeding, conveyance, and ejection of a recording medium and other devices referred to as a pretreatment device or an aftertreatment device.

The recording apparatus and the recording method may include a heater for use in a heating process and a dryer for use in a drying process. Examples of the heater and the dryer include, but are not limited to, units for heating and drying a printed side and a backside of a recording medium. The heater and the dryer are not particularly limited. Available examples thereof include, but are not limited to, fan heaters and infrared heaters. Heating and drying may be performed either before, during, or after printing. It is preferable that the base material to which the fabric inkjet ink is applied is heated to 120° C. or higher by the heater or the dryer.

In addition, the recording apparatus and the recording method are not limited to those that visualizes a meaningful image such as a text or a figure with ink. Examples thereof also include, but are not limited to, apparatuses for or methods of forming patterns or the like such as geometric designs, and apparatuses for or methods of shaping three-dimensional images.

The heater and the dryer may be independent from the recording apparatus, and the heating process and the drying process may be performed by a user.

The recording apparatus includes both a serial-type device having a movable discharge head and a line-type device having an immovable discharge head, unless otherwise specified.

Furthermore, in addition to a desktop apparatus, the recording apparatus also includes a wide recording apparatus that allows printing onto a recording medium with A0 size, and a continuous printer that allows use of continuous paper, e.g., reeled up in a roll form, as a recording medium.

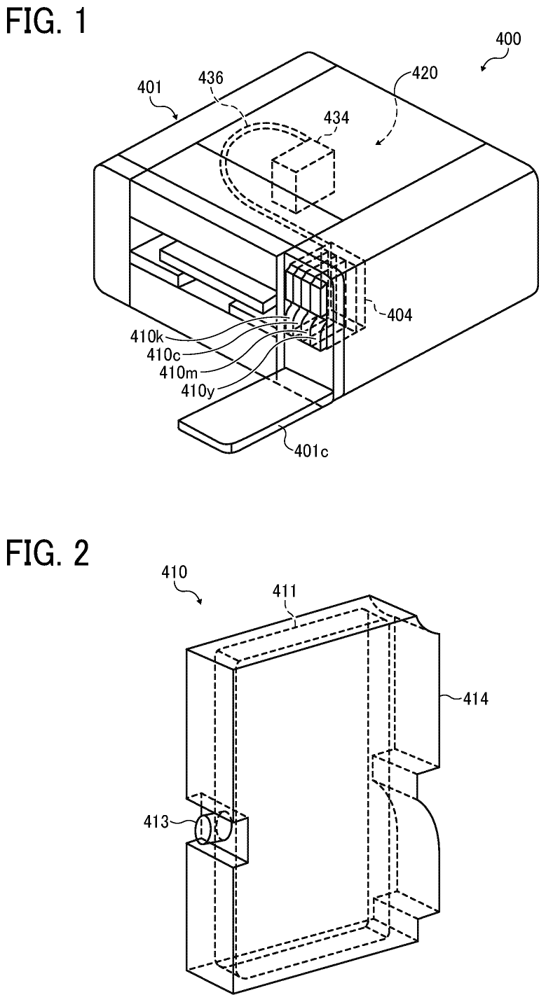

One example of the recording apparatus will be described below with reference to FIGS. 1 and 2. FIG. 1 is a perspective view of an inkjet recording apparatus that uses a fabric inkjet ink according to an aspect of the present embodiment. FIG. 2 is a perspective view of a main tank in the inkjet recording apparatus that uses a fabric inkjet ink according to an aspect of the present embodiment. An inkjet recording apparatus 400 as an example of an inkjet recording apparatus is a serial-type image forming apparatus. A housing 401 of the inkjet recording apparatus 400 encloses a mechanical section 420.

Main tanks 410 for respective colors of black (K), cyan (C), magenta (M), and yellow (Y) (410k, 410c, 410m, and 410y) have each an ink container 411 formed of a packaging material such as an aluminum laminate film. The ink container 411 is accommodated in a container casing 414 made of e.g., plastic. Thus, the main tank 410 is used as an ink cartridge of each color.

Meanwhile, upon opening of a cover 401c of the inkjet recording apparatus body, a cartridge holder 404 is disposed on the rear side of the opening. To the cartridge holder 404, the main tank 410 is removably attached. Thus, each ink discharging outlet 413 of the main tank 410 communicates with an discharge head 434 for each color via a supplying tube 436 for each color, thereby allowing discharge of ink from the discharge head 434 to a recording medium.

The recording apparatus can include not only a portion to discharge an ink containing a color material and a resin, but also a portion to provide a treatment liquid composition for pretreatment before application of the ink to a recording medium.

Examples of a method of providing a treatment liquid composition to a recording medium include, but are not limited to, a method of immersing a recording medium into a treatment liquid composition (immersion application), a method of applying a treatment liquid composition with a roll coater (roller application), a method of spraying a treatment liquid composition with a spray device or the like (spraying application), and a method of spraying a treatment liquid composition with an inkjet system (inkjet application), and any of these methods may be used.

In particular, in view of having a simple configuration of a device and allowing quick application of a treatment liquid composition, preferably employed are immersion application, roller application, and spraying application.

The terms “image forming”, “recording”, and “printing” in the present embodiment are treated as synonyms.

The terms “recording media”, “media”, and “media to be printed” are treated as synonyms.

### Examples

Embodiments of the present invention will now be described in detail below with reference to examples and comparative examples, but the scope of the present invention is not limited to such examples.

Preparation of each liquid and evaluation were performed under conditions at a room temperature of 25° C. and a humidity of 60% unless otherwise noted.

### (Preparation of Acrylic Silicone Resin Emulsion C)

### (1) Preparation of Emulsion Composition Containing Organopolysiloxan

A solution of 555 g of octamethylcyclotetrasiloxane (D4), 0.6 g of KBM-502 (γ-methacryloxypropyl methyldimethoxysilane), 44 g of KBE-13 (methyltriethoxysilane), and 6 g of sodium lauryl sulfate in 54 g of ion-exchanged water, and a solution of 6 g of dodecylbenzenesulfonic acid in 54 g of pure water were charged into a 2-L polyethylene beaker, uniformly emulsified with a homo-mixer, then diluted by gradual addition of 430 g of ion-exchanged water, and passed twice through a high-pressure homogenizer under a pressure of 300 kgf/cm², thereby providing a homogeneous white emulsion.

The emulsion thus obtained was transferred to a 2-L glass flask including a stirrer, a thermometer, and a reflux cooler, subjected to a polymerization reaction at 50 to 70° C. for 24 hours, and then neutralized to pH 6 to 8 with 12 g of a 10% aqueous sodium carbonate solution, thereby yielding a silicone emulsion composition.

The silicone emulsion composition produced 44.5% by mass of non-volatile constituents after drying at 105° C. for 3 hours, and organopolysiloxane in the emulsion had a non-fluid soft gel form.

### (2) Production of Silicone-Acryl Graft Copolymerized Resin

To the silicone emulsion composition thus obtained, 225 g of methyl methacrylate (MMA) was dripped for 3 to 5 hours, and simultaneously, a peroxide and a reductant were added at 30° C. to perform a redox reaction to cause acryl graft copolymerization, thereby yielding acrylic silicone resin emulsion C.

The volume average particle diameter of resin particles in acrylic silicone resin emulsion C was measured with a particle size analyzer (NANOTRAC WAVE-UT151 manufactured by MicrotracBEL Corp.). A solution of acrylic silicone resin emulsion C was diluted with highly-pure water to a range that allows measurement of scattered light strength, and then the diluted solution was put into a cell and subjected to measurement, thereby deriving the volume average particle diameter of resin particles in acrylic silicone resin emulsion C.

The volume average particle diameter of resin particles in acrylic silicone resin emulsion C was 55 nm.

### (Preparation of Acrylic Silicone Resin Emulsion D)

Acrylic silicone resin emulsion D was prepared in the same manner as in preparation of acrylic silicone resin emulsion C except for using 100 g of methacrylic acid and 115 g of ethylhexyl acrylate instead of 225 g of methyl methacrylate in production of the silicone-acryl graft copolymerized resin.

The volume average particle diameter of resin particles in acrylic silicone resin emulsion D was derived in the same manner as in acrylic silicone resin emulsion C. Resin particles in acrylic silicone resin emulsion D had a volume average particle diameter of 210 nm.

### (Preparation of Acrylic Silicone Resin Emulsion E)

Acrylic silicone resin emulsion E was prepared in the same manner as in preparation of acrylic silicone resin emulsion C except for reducing the amount of methyl methacrylate to 100 g in production of the silicone-acryl graft copolymerized resin.

The volume average particle diameter of resin particles in acrylic silicone resin emulsion E was derived in the same manner as in acrylic silicone resin emulsion C. Resin particles in acrylic silicone resin emulsion E had a volume average particle diameter of 310 nm.

### (Preparation of Urethane Resin Emulsion C)

To a four-neck flask including a stirrer, a reflux cooling tube, a thermometer and a nitrogen blowing tube, 75 g of polyester polyol with Mn=3500 (POLYLITE OD-X-2523, manufactured by DIC Corporation), 90 g of dicyclohexyl methanediisocyanate (H12MDI), and 200 g of acetone were added, and subjected to a reaction at 75° C. for 4 hours, thereby yielding an acetone solution of urethane prepolymer.

The solution thus obtained was cooled to 40° C., followed by gradual addition of 450 g of water, and subjected to emulsification/dispersion using a homogenizer.

Subsequently, an aqueous solution containing 15 g of 2-methyl-1,5-pentanediamine dissolved in 100 g of water was added, and kept stirring for 1 hour.

The product was subjected to desolventization at 50° C. under reduced pressure, thereby yielding urethane resin emulsion C with about 45% by mass of non-volatile constituents.

The volume average particle diameter of resin particles in urethane resin emulsion C was derived in the same manner as in acrylic silicone resin emulsion C. Resin particles in urethane resin emulsion C had a volume average particle diameter of 100 nm.

### (Preparation of Urethane Resin Emulsion D)

Urethane resin emulsion D was prepared in the same manner as in preparation of urethane resin emulsion C except for using polyether polyol with Mn=3200 (EXCENOL 3020, manufactured by AGC Inc.) instead of polyester polyol (POLYLITE OD-X-2523, manufactured by DIC Corporation).

The volume average particle diameter of resin particles in urethane resin emulsion D was derived in the same manner as in acrylic silicone resin emulsion C. Resin particles in urethane resin emulsion D had a volume average particle diameter of 10 nm.

### (Urethane Resin Emulsion F)

Urethane resin emulsion F was prepared in the same manner as in preparation of urethane resin emulsion C except for using polycarbonate polyol (ETERNACOLL UH-100, manufactured by UBE Corporation) instead of polyester polyol (POLYLITE OD-X-2523, manufactured by DIC Corporation).

The volume average particle diameter of resin particles in urethane resin emulsion F was derived in the same manner as in acrylic silicone resin emulsion C. Resin particles in urethane resin emulsion F had a volume average particle diameter of 13 nm.

### <Preparation of Black Pigment Dispersion A>

### —Preparation of Polymer Solution A—

In a 1-L flask including a mechanical stirrer, a thermometer, a nitrogen gas inlet pipe, a reflux pipe, and a dropping funnel, the inner air was sufficiently replaced with nitrogen gas, and then 11.2 g of styrene, 2.8 g of acrylic acid, 12.0 g of lauryl methacrylate, 4.0 g of polyethylene glycol methacrylate, 4.0 g of styrene macromer, and 0.4 g of mercaptoethanol were mixed and heated to 65° C.

Next, a mixture solution containing 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer, 3.6 g of mercaptoethanol, 2.4 g of azobis methylvaleronitrile, and 18 g of methyl ethyl ketone was dropped in the flask over a period of 2.5 hours.

After the instillation, a mixture solution containing 0.8 g of azobis methylvaleronitrile and 18 g of methyl ethyl ketone was dropped in the flask over a period of 0.5 hours.

After aging of the mixture at 65° C. for 1 hour, 0.8 g of azobis methylvaleronitrile was added thereto, and the mixture was further aged for 1 hour. After completion of the reaction, 364 g of methyl ethyl ketone was added to the flask, thereby producing 800 g of polymer solution A with a concentration of 50% by mass.

### —Preparation of Dispersion Liquid of Pigment-Containing Polymer Microparticles—

A mixture of 28 g of polymer solution A, 42 g of a carbon black pigment (product name: MONARCH 800, manufactured by Cabot Corporation), 13.6 g of a 1 mol/L aqueous potassium hydroxide solution, 20 g of methylethylketone, and 13.6 g of ion-exchanged water was sufficiently stirred, and then kneaded with a roll mill.

The paste thus obtained was put into 200 g of pure water, and sufficiently stirred, followed by distillation off of methylethylketone and water with an evaporator, and further, the dispersion liquid was subjected to pressure filtration with a polyvinylidene fluoride membrane filter having an average pore size of 5.0 μm in order to remove coarse particles, thereby yielding resin-covered black pigment dispersion A having a pigment concentration of 15% by mass and a solid content concentration of 20% by mass.

### <Preparation of Cyan Pigment Dispersion A>

Resin-covered cyan pigment dispersion A was prepared in the same manner as in the preparation of black pigment dispersion A except for using Pigment Blue 15:4 (SMART Cyan 3154BA manufactured by Sensient Technologies Corporation) instead of carbon black.

### <Preparation of Magenta Pigment Dispersion A>

Resin-covered magenta pigment dispersion A was prepared in the same manner as in the preparation of black pigment dispersion A except for using Pigment Red 122 (Pigment Red 122 manufactured by Sun Chemical Corporation) instead of carbon black.

### <Preparation of Yellow Pigment Dispersion A>

Resin-covered yellow pigment dispersion A was prepared in the same manner as in the preparation of black pigment dispersion A except for using Pigment Yellow 74 (SMART Yellow 3074BA manufactured by Sensient Technologies Corporation) instead of carbon black.

### <Preparation of White Pigment Dispersion A>

Resin-covered white pigment dispersion A was prepared in the same manner as in the preparation of black pigment dispersion A except for using Pigment White 6 (titanium oxide TITONE R-25 manufactured by Sakai Chemical Industry Co., Ltd.) instead of carbon black.

### <Preparation of Black Pigment Dispersion B>

To 3000 mL of a 2.5 N (normal) sodium hypochlorite solution, 100 g of carbon black SEAST SP (SRF-LS) manufactured by Tokai Carbon Co., Ltd. was added, stirred at a temperature of 60° C. and a rate of 300 rpm, and allowed to react for 10 hours to perform oxidation, thereby yielding a pigment including a carboxyl group provided onto a surface of carbon black.

The reaction solution was filtrated, and the carbon black separated by the filtration was neutralized with a sodium hydroxide solution and subjected to ultrafiltration.

Subsequently, the pigment dispersion and ion-exchanged water was used to perform ultrafiltration with a dialysis membrane, further followed by sonication dispersion to concentrate pigment solid contents to 20% by mass, thereby yielding self-dispersible black pigment dispersion B.

### <Preparation of Black Pigment Dispersion C>

A mixture having the following formulation was preliminarily mixed, and then subjected to circulation dispersion for 7 hours with a disk-type bead mill (available from Shinmaru Enterprises Corporation; KDL type; media: employing a zirconia ball with a diameter of 0.3 mm), thereby yielding black pigment dispersion C (pigment concentration: 15% by mass) as a surfactant-type black pigment dispersion.
15 parts of carbon black pigment (product name: MONARCH 800, manufactured by Cabot Corporation)
2 parts of an anionic surfactant (product name: PIONINE A-51-B, manufactured by Takemoto Oil & Fat Co., Ltd.)
83 parts of ion-exchanged water

### <Preparation of Inkjet Ink>

Materials were mixed and stirred in the formulation and content (% by mass) described in the following Tables 1 and 2, and filtrated with a 0.8 μm filter (MINISART, manufactured by Sartorius AG), thereby yielding a liquid composition to be an ink used in Examples 1 to 15 or Comparative Examples 1 to 6.

As the additive amounts of the resin emulsions and the pigment dispersions in Tables 1 and 2, the additive amounts of solid contents of the resin and the pigment are described. Details of additives used are as follows:
Acrylic silicone resin emulsion A: CHALINE FE230N (manufactured by Nissin Chemical Co., Ltd.; volume average particle diameter of resin particles: 250 nm)
Acrylic silicone resin emulsion B: VONCOAT SA6360 (manufactured by DIC corporation; volume average particle diameter: 80 nm)
Urethane resin emulsion A: SUPERFLEX 210 (manufactured by DKS Co., Ltd. polyester-based polyurethane, volume average particle diameter of resin particles: 40 nm)
Urethane resin emulsion B: SUPERFLEX 130 (manufactured by DKS Co., Ltd. polyether-based polyurethane, volume average particle diameter of resin particles: 30 nm)
Urethane resin emulsion E: SUPERFLEX 130 (manufactured by DKS Co., Ltd. polyether-based polyurethane, volume average particle diameter of resin particles: 13 nm)
Surfactant A: BYK348 (silicone-based surfactant manufactured by BYK-Chemie GmbH)
Surfactant B: Zonyl FS-100 (fluorine-based surfactant manufactured by The Chemors Company)
PROXEL LV (antiseptic manufactured by Avecia Inc. (present Arxada LLC.))

### <Volume Average Particle Diameter of Resin Particles>

The volume average particle diameter of particle diameters of resin particles in each resin emulsion added to the aforementioned ink was defined as the volume average particle diameter of acrylic silicone resin particles and urethane resin particles in each ink (Tables 1 and 2). Since the ink in Example 14 contained urethane resin emulsion A and urethane resin emulsion B, the volume average particle diameter of urethane resin particles was derived by mixing urethane resin emulsion A and urethane resin emulsion B at the ratio described in Table 1 to preliminarily prepare an emulsion mixture, and performing the method described in the paragraph 35. Since the ink in Example 15 contained urethane resin emulsion A and urethane resin emulsion C, the volume average particle diameter of urethane resin particles was derived, as well, by mixing urethane resin emulsion A and urethane resin emulsion C at the ratio described in Table 1 to preliminarily preparing a mixture, and performing measurement by the method described in the paragraph 35 (Tables 1 and 2).

### <Measurement of Glass Transition Temperature (Tg)>

To a TEFLON dish, 5 g of one of the inks prepared in Examples 1 to 15 and Comparative Examples 1 to 6 was charged, heated at 40° C. for 12 hours, dried at 150° C. for 12 hours, and then dried under reduced pressure at 150° C. for 3 hours, thereby yielding a dried ink film, which is a dried ink substance.

The glass transition temperature (Tg) of the dried ink substance was measured as the followings by using the DSC system Q-2000 (manufactured by TA Instruments Ltd.). Each measurement result are as present in Tables 1 and 2.

First, about 5.0 mg of a dried ink film in a sample container made of aluminum was set in the device, and subjected to measurement in nitrogen stream under the following measurement conditions. A DSC curve in the second heating was selected and subjected to calculation for glass transition temperature by a midpoint method.

### [Measurement Conditions]

Cooling to −70° C. and then keeping for 5 minutes
Heating to 120° C. at 10° C./min
Cooling to −70° C. and then keeping for 5 minutes
Heating to 120° C. at 10° C./min

The inks according to Examples 1 to 15 and Comparative Examples 1 to 6 were evaluated for characteristics of base materials (fabrics) where the inks were applied, as follows. The results are summarized in Tables 1 and 2.

### <Evaluation of Texture>

A set of the liquid compositions (inks) in Examples 1 to 15 and Comparative Examples 1 to 6 was filled in Ri100 manufactured by Ricoh Company Ltd., and adjusted so as to provide the liquid compositions with an attached amount of 1.9 mg/cm², and subsequently, each of the inks was used to print a solid image onto a cotton broad fabric manufactured by Shikisensya Co., Ltd., which is a fabric base material, with 600×600 dpi, and then dried at 120° C. for 120 seconds with a heat press, thereby yielding a recorded matter.

A printing area in the aforementioned recorded matter was directly touched with the hand, and the touch was judged based on the following criteria. The judgement was performed by three members, and a view supported by most members was defined as a result of the judgement. If the judgement was divided per member, a moderate view thereof was subjected to judgement.

B or more indicates a range that allows implementation.

### (Evaluation Criteria)

A: a printing area has good hardness and hand feel almost as the same as an original fabric.
B: a printing area appears to have hardness or hand feel changed a little from an original fabric.
C: a printing area has hardness or hand feel clearly deteriorated relative to an original fabric.

### <Evaluation of Dry Friction Fastness>

In the recorded matter that included a solid image printed onto a cotton broad fabric and was prepared in the evaluation of texture described above, a test for friction fastness (dry friction) was performed with use of a Gakushin-type friction fastness tester in accordance with Japanese Industrial Standards (JIS) JIS L0849, to measure transfer OD (post-transfer absorbance) of the solid image on the cotton broad fabric and make a judgment according to the following criteria.

B or more indicates a range that allows implementation.

### (Evaluation Criteria)

A: a solid image on a cotton broad fabric after the test has a transfer OD of less than 0.15.
B: a solid image on a cotton broad fabric after the test has a transfer OD of 0.15 or more to less than 0.20.
C: a solid image on a cotton broad fabric after the test has a transfer OD of 0.20 or more.

### <Evaluation of Wet Friction Fastness>

In evaluation of the dry friction fastness as described above, a cotton broad fabric was preliminarily moistened, then subjected to a friction fastness test as well, and evaluated based on the following criteria.

B or more indicates a range that allows implementation.

### (Evaluation Criteria)

A: a solid image on a cotton broad fabric after the test has a transfer OD of less than 0.15.
B: a solid image on a cotton broad fabric after the test has a transfer OD of 0.15 or more to less than 0.20.
C: a solid image on a cotton broad fabric after the test has a transfer OD of 0.20 or more.

[symbol]

TABLE 1

| | | | Example | Example | Example | Example | Example | Example | Example | Example |
|---|---|---|---|---|---|---|---|---|---|---|
| | | | 1 | 2 | 3 | 5 | 5 | 6 | 7 | 8 |
| Ink | Water- | 1,2-Propanediol | 20.0 | 20.0 | | | 20.0 | 20 | 20 | 20 |
| formulation | soluble | Glycerin | | | 20.0 | 25.0 | | | | |
| | organic | Triethylene glycol | 10.0 | | | | | 10 | 10 | 10 |
| | solvent | monobutyl ether | | | | | | | | |
| | | 1,2-Hexanediol | | | 10.0 | | | | | |
| | | Diethylene glycol | | 8.0 | | | | | | |
| | | monobutyl ether | | | | | | | | |
| | | 2-Ethyl-1,3- | | | | 4.0 | | | | |
| | | hexanediol | | | | | | | | |
| | | Propylene glycol | | | | | 10.0 | | | |
| | | monomethyl ether | | | | | | | | |
| | Additive | Surfactant A | 1.0 | 0.5 | | | 0.5 | 1 | 1 | 1 |
| | | Surfactant B | | | 1.0 | 1.0 | 0.5 | | | |
| | Acrylic | Acrylic silicone | 3.0 | | | | 3.0 | | 3.0 | 4.0 |
| | silicone | resin emulsion A | | | | | | | | |
| | resin | Acrylic silicone | | 4.0 | | | | | | |
| | | resin emulsion B | | | | | | | | |
| | | Acrylic silicone | | | 5.0 | | | | | |
| | | resin emulsion C | | | | | | | | |
| | | Acrylic silicone | | | | 2.5 | | | | |
| | | resin emulsion D | | | | | | | | |
| | | Acrylic silicone | | | | | | 3.0 | | |
| | | resin emulsion E | | | | | | | | |
| | | Volume average | 250 | 80 | 55 | 210 | 250 | 310 | 250 | 250 |
| | | particle diameter | | | | | | | | |
| | | of emulsion | | | | | | | | |
| | | particles (nm) | | | | | | | | |
| | Urethane | Urethane resin | 6.0 | | | | | 6.0 | | |
| | resin | emulsion A | | | | | | | | |
| | | Urethane resin | | 6.0 | | | | | | |
| | | emulsion B | | | | | | | | |
| | | Urethane resin | | | 5.0 | | 6.0 | | | 6.0 |
| | | emulsion C | | | | | | | | |
| | | Urethane resin | | | | 7.5 | | | | |
| | | emulsion D | | | | | | | | |
| | | Urethane resin | | | | | | | 6.0 | |
| | | emulsion E | | | | | | | | |
| | | Urethane resin | | | | | | | | |
| | | emulsion F | | | | | | | | |
| | | Volume average | 40 | 30 | 100 | 10 | 100 | 40 | 13 | 100 |
| | | particle diameter | | | | | | | | |
| | | of emulsion | | | | | | | | |
| | | particles (nm) | | | | | | | | |
| | Pigment | Black pigment | 6.0 | | | | 5.0 | 6.0 | 6.0 | 6.0 |
| | | dispersion A | | | | | | | | |
| | | Cyan pigment | | 3.0 | | | | | | |
| | | dispersion A | | | | | | | | |
| | | Magenta pigment | | | 4.0 | | | | | |
| | | dispersion A | | | | | | | | |
| | | Yellow pigment | | | | 3.0 | | | | |
| | | dispersion A | | | | | | | | |
| | | White pigment | | | | | | | | |
| | | dispersion A | | | | | | | | |
| | | Black pigment | | | | | | | | |
| | | dispersion B | | | | | | | | |
| | | Black pigment | | | | | | | | |
| | | dispersion C | | | | | | | | |
| | Antiseptic | PROXEL LV | 0.1 | 0.1 | 0.1 | 0.1 | 0.1 | 0.1 | 0.1 | 0.1 |
| | Water | Highly-pure water | rest | rest | rest | rest | rest | rest | rest | rest |

| | | | | | | | | | |
|---|---|---|---|---|---|---|---|---|---|
| | Total content (sum) | 100 | 100 | 100 | 100 | 100 | 100 | 100 | 100 |
| Measurement | Glass transition temperature | 20 | −21 | 25 | −33 | −39 | 20 | 20 | −41 |
| result | (Tg) | | | | | | | | |
| Evaluation | Texture | A | A | A | A | A | B | A | A |
| result | Dry friction fastness | A | A | A | A | A | A | A | B |
| | Wet friction fastness | A | A | A | A | A | B | B | B |

| | | | Example | Example | Example | Example | Example | Example | Example |
|---|---|---|---|---|---|---|---|---|---|
| | | | 9 | 10 | 11 | 12 | 13 | 14 | 15 |
| Ink | Water- | 1,2-Propanediol | 20 | 20 | 20 | 15.0 | 15.0 | 20.0 | 20.0 |
| formulation | soluble | Glycerin | | | | | | | |
| | organic | Triethylene glycol | 10 | 10 | 10 | 2.5 | 2.5 | 10.0 | 10.0 |
| | solvent | monobutyl ether | | | | | | | |
| | | 1,2-Hexanediol | | | | | | | |
| | | Diethylene glycol | | | | | | | |
| | | monobutyl ether | | | | | | | |
| | | 2-Ethyl-1,3- | | | | | | | |
| | | hexanediol | | | | | | | |
| | | Propylene glycol | | | | | | | |
| | | monomethyl ether | | | | | | | |
| | Additive | Surfactant A | 1.0 | 1 | 1 | 1.0 | 1.0 | 1.0 | 1.0 |
| | | Surfactant B | | | | | | | |
| | Acrylic | Acrylic silicone | 3.0 | 3.0 | 3.0 | | | 3.0 | 3.0 |
| | silicone | resin emulsion A | | | | | | | |
| | resin | Acrylic silicone | | | | 3.0 | 3.0 | | |
| | | resin emulsion B | | | | | | | |
| | | Acrylic silicone | | | | | | | |
| | | resin emulsion C | | | | | | | |
| | | Acrylic silicone | | | | | | | |
| | | resin emulsion D | | | | | | | |
| | | Acrylic silicone | | | | | | | |
| | | resin emulsion E | | | | | | | |
| | | Volume average | 250 | 250 | 250 | 80 | 80 | 250 | 250 |
| | | particle diameter | | | | | | | |
| | | of emulsion | | | | | | | |
| | | particles (nm) | | | | | | | |
| | Urethane | Urethane resin | 7.5 | 6.0 | 6.0 | 6.0 | 6.0 | 3.0 | 2.0 |
| | resin | emulsion A | | | | | | | |
| | | Urethane resin | | | | | | 3.0 | |
| | | emulsion B | | | | | | | |
| | | Urethane resin | | | | | | | 4.0 |
| | | emulsion C | | | | | | | |
| | | Urethane resin | | | | | | | |
| | | emulsion D | | | | | | | |
| | | Urethane resin | | | | | | | |
| | | emulsion E | | | | | | | |
| | | Urethane resin | | | | | | | |
| | | emulsion F | | | | | | | |
| | | Volume average | 40 | 40 | 40 | 40 | 40 | 33 | [symbol] |
| | | particle diameter | | | | | | | |
| | | of emulsion | | | | | | | |
| | | particles (nm) | | | | | | | |
| | Pigment | Black pigment | 6.0 | | | 4.0 | | 6.0 | 6.0 |
| | | dispersion A | | | | | | | |
| | | Cyan pigment | | | | | | | |
| | | dispersion A | | | | | | | |
| | | Magenta pigment | | | | | | | |
| | | dispersion A | | | | | | | |
| | | Yellow pigment | | | | | | | |
| | | dispersion A | | | | | | | |
| | | White pigment | | | | | 8.0 | | |
| | | dispersion A | | | | | | | |
| | | Black pigment | | 6.0 | | | | | |
| | | dispersion B | | | | | | | |
| | | Black pigment | | | 6.0 | | | | |
| | | dispersion C | | | | | | | |
| | Antiseptic | PROXEL LV | 0.1 | 0.1 | 0.1 | 0.1 | 0.1 | 0.1 | 0.1 |
| | Water | Highly-pure water | rest | rest | rest | rest | rest | rest | rest |

| | | | | | | | | |
|---|---|---|---|---|---|---|---|---|
| | Total content (sum) | 100 | 100 | 100 | 100 | 100 | 100 | 100 |
| Measurement | Glass transition temperature | 27 | 20 | 20 | 11 | 18 | −15 | 21 |
| result | (Tg) | | | | | | | |
| Evaluation | Texture | A | B | B | A | A | A | A |
| result | Dry friction fastness | B | B | B | A | A | A | A |
| | Wet friction fastness | B | B | B | A | A | A | A |

[symbol]

indicates data missing or illegible when filed

[symbol]

TABLE 2

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Ink | Water- | 1,2-Propanediol | 20 | 20 | 20 | 20 | 20 | 20 |
| formulation | soluble | Glycerin | | | | | | |
| | organic | Triethylene glycol monobutyl ether | 10 | 10 | 10 | 10 | 10 | |
| | solvent | 1,2-Hexanediol | | | | | | |
| | | Diethylene glycol monobutyl ether | | | | | | |
| | | 2-Ethyl-1,3-hexanediol | | | | | | |
| | | Propylene glycol monomethyl ether | | | | | | |
| | Additive | Surfactant A | 1 | 1 | 1 | 1 | 1 | 1 |
| | | Surfactant B | | | | | | |
| | Acrylic | Acrylic silicone resin emulsion A | | 3.0 | [symbol] .0 | 3.0 | 3.0 | 3.0 |
| | silicone | Acrylic silicone resin emulsion B | | | | | | |
| | resin | Acrylic silicone resin emulsion C | | | | | | |
| | | Acrylic silicone resin emulsion D | | | | | | |
| | | Acrylic silicone resin emulsion E | | | | | | |
| | | Volume average particle diameter | — | 250 | 250 | 250 | 250 | 250 |
| | | of emulsion particles (nm) | | | | | | |
| | Urethane | Urethane resin emulsion A | 9.0 | | | 10.5 | 2.4 | [symbol] .0 |
| | resin | Urethane resin emulsion B | | | | | | |
| | | Urethane resin emulsion C | | | | | | |
| | | Urethane resin emulsion D | | | | | | |
| | | Urethane resin emulsion E | | | | | | |
| | | Urethane resin emulsion F | | 6.0 | | | | |
| | | Volume average particle diameter | 40 | 13 | — | 40 | 40 | 40 |
| | | of emulsion particles (nm) | | | | | | |
| | Pigment | Black pigment dispersion A | [symbol] | [symbol] | [symbol] | [symbol] | [symbol] | [symbol] |
| | | Cyan pigment dispersion A | | | | | | |
| | | Magenta pigment dispersion A | | | | | | |
| | | Yellow pigment dispersion A | | | | | | |
| | | White pigment dispersion A | | | | | | |
| | | Black pigment dispersion B | | | | | | |
| | | Black pigment dispersion C | | | | | | |
| | Antiseptic | PROXEL LV | 0.1 | 0.1 | 0.1 | 0.1 | 0.1 | 0.1 |
| | Water | Highly-pure water | rest | rest | rest | rest | rest | rest |

| | | | | | | | |
|---|---|---|---|---|---|---|---|
| | Total content (sum) | 100 | 100 | 100 | 100 | 100 | 100 |
| Measurement | Glass transition temperature (Tg) | −20 | −34 | 31 | 22 | [symbol] | 20 |
| result | | | | | | | |
| Evaluation | Texture | C | B | A | C | A | C |
| result | Dry friction fastness | B | B | C | A | C | A |
| | Wet friction fastness | C | C | C | B | B | C |

[symbol]

indicates data missing or illegible when filed

The inks in Examples 1 to 15 provided fabrics with texture, dry friction fastness, and wet friction fastness each having the grade “A” or “B”, falling within a range that allows implementation of the present embodiment.

The ink in Comparative Example 1 contained no acrylic silicone resin and provided no lubricity from an acrylic silicone resin, thus failing to reduce a friction coefficient and resulting in the grade “C” in texture and wet friction fastness.

The ink in Comparative Example 2 contained neither a polyester-based urethane resin nor a polyether-based urethane resin, thus resulting in the grade “C” in wet friction fastness.

The ink in Comparative Example 3 contained no urethane resin and provided the ink with poor toughness and thus low friction fastness, resulting in the grade “C” in dry friction fastness and wet friction fastness.

The ink in Comparative Example 4 contained an acrylic silicone resin and a urethane resin at a mass ratio of 1:3.5, which indicates presence of more content of the urethane resin with exceeding 1:3, thus resulting in the grade “C” in texture.

The ink in Comparative Example 5 contained an acrylic silicone resin and a urethane resin at a mass ratio of 1:0.8, which indicates presence of more content of the acrylic silicone resin with exceeding 1:1, thus causing shortage of toughness supplied from the urethane resin, and resulting in the grade “C” in dry friction fastness.

The ink in Comparative Example 6 contained a water-soluble organic solvent containing neither glycol ethers nor glycols with six or more carbon atoms, and thus provided the ink with reduced wettability to a base material and reduced adhesion between the ink and the base material, causing reduced fusion of a resin to a base material and thereby poor fastness of a film, and resulting in the grade “C” in texture and wet friction fastness.

These results have demonstrated that an ink that meets a composition according to the present embodiment is a fabric inkjet ink that allows providing an image having excellent in friction fastness without impairing texture.

Aspects of the present invention include the following items.

In Aspect 1, a fabric inkjet ink contains water, a water-soluble organic solvent, a resin, and a pigment. The water-soluble organic solvent comprises at least one member selected from the group consisting of glycol ethers and glycols having six or more carbon atoms. The resin comprises an acrylic silicone resin and a urethane resin at a mass ratio of from 1:1 to 1:3, and the urethane resin comprises at least one member selected from the group consisting of polyester-based urethane resins and polyether-based urethane resins.

In Aspect 2, in the fabric inkjet ink of Aspect 1, the acrylic silicone resin is in the form of particles having a volume average particle diameter of from 10 nm to 300 nm, and the urethane resin is in the form of particles having a volume average particle diameter of from 10 nm to 300 nm.

In Aspect 3, in the fabric inkjet ink of any of Aspects 1 to 2, dry matter of the fabric inkjet ink has a glass transition temperature (Tg) of from −40° C. to 25° C.

In Aspect 4, in the fabric inkjet ink of any of Aspect 1 to 3, the pigment is a resin-covered pigment.

In Aspect 5, an inkjet recording method includes: applying the fabric inkjet ink of any of Aspects 1 to 4 to a base material; and heating the base material to which the fabric inkjet ink is applied to 120° C. or higher.

In Aspect 6, recorded matter is recorded by the inkjet recording method of Aspect 5.

The fabric inkjet ink set forth in any of Aspects 1 to 4, the inkjet recording method set forth in Aspect 5, and the recorded matter set forth in Aspect 6 can solve various conventional problems, and achieve a purpose of the present embodiment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A fabric inkjet ink comprising:
water;
a water-soluble organic solvent comprising at least one member selected from the group consisting of glycol ethers and glycols having six or more carbon atoms;
a resin comprising an acrylic silicone resin and a urethane resin at a mass ratio of from 1:1 to 1:3, the urethane resin comprising at least one member selected from the group consisting of polyester-based urethane resins and polyether-based urethane resins; and
a pigment.

2. The fabric inkjet ink according to claim 1, wherein the acrylic silicone resin is in the form of particles having a volume average particle diameter of from 10 nm to 300 nm, and the urethane resin is in the form of particles having a volume average particle diameter of from 10 nm to 300 nm.

3. The fabric inkjet ink according to claim 1, wherein dry matter of the fabric inkjet ink has a glass transition temperature (Tg) of from −40° C. to 25° C.

4. The fabric inkjet ink according to claim 1, wherein the pigment is a resin-covered pigment.

5. An inkjet recording method comprising:
applying the fabric inkjet ink according to claim 1 to a base material; and
heating the base material to which the fabric inkjet ink is applied to 120° C. or higher.

6. Recorded matter recorded by the inkjet recording method according to claim 5.
